(19) United States
(12) Patent Application Publication
(10) Pub. No.: US 2020/0410039 A1
(43) Pub. Date: Dec. 31, 2020

(54) DATA COMPARISON ARITHMETIC PROCESSOR AND METHOD OF COMPUTATION USING SAME

(71) Applicant: Katsumi INOUE, Chiba (JP)

(72) Inventor: Katsumi INOUE, Chiba (JP)

(21) Appl. No.: 16/464,154

(22) PCT Filed: Nov. 28, 2017
(86) PCT No.: PCT/JP2017/042655

§ 371 Date: Aug. 10, 2020

(30) Foreign Application Priority Data
Nov. 28, 2016 (JP) 2016-229677

(51) Int. Cl. G06F 17/16; G06F 7/57; G06F 16/22

(52) U.S. Cl. CPC G06F 17/16; G06F 16/221; G06F 7/57

(57) ABSTRACT

Since CPUs of the von Neumann-architecture computers perform sequential processing, comparison operations causing the combinatorial explosion lead to a very large volume of computing, making it difficult to speed up the processing even with high-performance processors.

There are provided 2 sets of memory groups consisting of 1 row and 1 column, each capable of storing n and m data items, and n+m data items in total; and n×m computing units at cross points of data lines wired in net-like manner from the 2 sets of memory groups, wherein the respective data items, consisting of n data items for 1 row and m data items for 1 column, are sent in parallel to the data lines wired in net-like manner from the 2 sets of memories of 1 row and 1 column to thereby cause the n×m computing units to read the sent data items of the rows and columns exhaustively and combinatorially, to perform parallel comparison operations on the data items of the rows and columns exhaustively and combinatorially, and to output results of the comparison operations.

### FIELD OF THE INVENTION

The invention relates to a data comparison operation processor and an operation method for using the same.

### BACKGROUND OF THE INVENTION

In von Neumann-architecture computers, programs for describing operational processing are stored in a main storage section, and the operational processing is executed by a central control unit (CPU) in a sequential processing scheme. Most of the common computer systems today are such von Neumann-architecture computers.

Since CPUs of the von Neumann-architecture computers perform sequential processing, those CPUs have a structural limitation to accommodate exhaustive comparison operations or combinatorial comparison operations, for example, big data processing, which may cause the combinatorial explosion. Although the processing speed has been improved by processors with higher performance and/or parallel processing, these improvements are costly and consume excessive electric power.

For this reason, in order to accommodate combinatory search computation such as big data mining, various techniques using software algorithms have been devised to prevent the combinatorial explosion. However, the usage of such software algorithms requires specialized skills, making it difficult for non-experts to use such software algorithms.

Thus, there exists a need for achieving computing units, mostly using hardware, for operating in simpler and more affordable configurations, requiring less electricity and enabling to execute exhaustive comparison operations.

Relevant prior art publications of the present invention include the following: Patent Publication 1: Japanese Translation of PCT International Application Publication No. 2003-524831 (P2003-524831A)

Patent Publication 2: Japanese Patent Application No. H04-18530

### Patent Publication 3: Japanese Patent No. 5981666

Japanese Translation of PCT International Application Publication No. 2003-524831 (P2003-524831A), “SYSTEM AND METHOD FOR SEARCHING IN COMBINATORIAL SPACE” discloses a method for performing a full search in a combinatorial space without causing the combinatorial explosion. The present invention enables an exhaustive data comparison by means of software.

Japanese Patent Application No. H4-18530 discloses a parallel data processing device and a microprocessor in a configuration where data lines are disposed in a matrix (rows and columns) with each row-column intersection having a data processing element (e.g., microprocessor) arranged thereon, in order to speed up data transmission between data processing elements. However, this configuration requires the data processing elements to select respective matrix (row and column) data lines, and therefore, is unable to achieve the goal of speeding up the exhaustive data comparisons.

Japanese Patent No. 598166 by the present inventor discloses a memory provided with an information search function and the memory's usage, device and information processing method. It is, however, incapable of executing exhaustive comparison operations.

The present invention focuses on comparison operations in the highest demand among exhaustive comparison operations to achieve a novel computing technology by incorporating new computing concepts, such as enabling the usage of an SIMD-type 1-bit computing unit for row-column (matrix) comparison operations and utilizing data lookahead effect and expanding the concept of a content-addressable memory (CAM), all of which may not be conceived according to the conventional computing methodology.

### SUMMARY OF THE INVENTION

As described above, exhaustive combinatorial comparison operations using serial processing processors, CPUs and/or GPUs, are costly, and time-consuming even with the most advanced processor technology.

Metadata such as indices not only has various problems including excessive indices being used and metadata updates, but also severely compromises the performance of ad hoc searches such as data mining, where optimal solutions are searched iteratively. Thus, building search engines for social media, WEB sites and/or large-scale cloud servers is practically impossible unless it is done by very large corporations.

Also, even though an amount of available data may increase significantly with the big data technology, realization of an efficient society based on IoT or AI is difficult with the conventional, old-fashioned computing.

An object of the present invention is to provide a one-chip processor for enabling super-fast and low-power exhaustive combinatorial comparison operations (i.e., significant improvement of power performance thereof), which are difficult using the current computer architectures to thereby solve the problem of both CPU/GPU load and user load, and enable information processing that has been otherwise out of reach to general users.

The invention of Claim 1 is characterized in that

the invention is provided with 2 sets of memory groups consisting of 1 row and 1 column, each capable of storing n and m data items, and n+m data items in total; and n×m computing units at cross points of data lines wired in net-like manner from the 2 sets of memory groups,
wherein the invention comprises means for sending in parallel the respective data items, consisting of n data items for 1 row and m data items for 1 column, to the data lines wired in net-like manner from the 2 sets of memories of 1 row and 1 column, and causing the n×m computing units to read the sent data items of the rows and columns exhaustively and combinatorially, to perform parallel comparison operations on the data items of the rows and columns exhaustively and combinatorially, and to output results of the comparison operations.

In Claim 2,

the data lines wired in net-like manner are characterized in that the data lines are multi-bit data lines, and the computing units are ALU (Arithmetic and Logic Unit) for executing matrix comparison operations in parallel.

In Claim 3,

the data lines wired in net-like manner are characterized in that the data lines are 1-bit data lines, and the computing units are 1-bit comparison computing units for executing matrix comparison operations in parallel.

In Claim 4,

the 1-bit comparison computing units are characterized in that the 1-bit comparison computing units
a) perform comparison operations for match or similarity;
b) perform comparison operations for large/small or range;
c) based on comparison operation results of either one or both of the a) orb) above, perform comparison operations for commonality; and/or
perform the comparison operations of any one or any combination of the above a), b) or c)
for the n data items for 1 row and the m data items for 1 column.

In Claim 5,

the 2 sets of memory groups of 1 row and 1 column are characterized in that the 2 sets of memory groups comprise a memory for storing exhaustive and combinatorial data in a matrix range, which is K times of data required for 1 batch of n×m exhaustive and combinatorial operations, wherein the n×m computing units comprise a function for continuously executing (K×n)×(K×m) exhaustive and combinatorial operations.

In Claim 6,

the invention is characterized in that it performs matrix transformation on the data items and stores them in the 2 sets of memories of 1 row and 1 column when externally reading and storing the n and m data items.

In Claim 7,

the invention is characterized in that the algorithm of Claim 1 is implemented in a FPGA.

In Claim 8,

the invention is characterized in that it is provided with 3 sets of memory groups consisting of the 1 row, 1 column, and additional 1 page, each capable of storing n, m, o data items, and n+m+o data items in total; and n×m×o computing units at cross points of data lines wired in net-like manner from the 3 sets of memory groups.

In Claim 9,

the invention is a device, which includes the data comparison operation processor of

In Claim 10,

the invention is characterized in that it comprises a method using the data comparison operation processor of Claim 1, the method comprising the steps of:
performing the parallel comparison operations using different data items in the 1 row and 1 column; and
executing either one of
a) performing n×m exhaustive comparison operations; or
b) taking data items in either one of 1 row or 1 column as comparison operation condition data items.

In Claim 11,

the invention is characterized in that it comprises a method using the data comparison operation processor of Claim 1, the method comprising the steps of:
performing the parallel comparison operations using identical data items in the 1 row and 1 column; and
executing either one of
a) performing n×n exhaustive comparison operations;
b) taking data items in either one of 1 row or 1 column as comparison operation condition data items; or
c) performing classification operations.

In Claim 12,

the invention is characterized in that it comprises a method using the data comparison operation processor of Claim 1, the method comprising the steps of:
taking data items in either one of the 1 row or 1 column as search index data items;
taking data items in the other one of the 1 row or 1 column as multi-access search query data items; and
performing comparison operations to execute a multi-access content-addressable search.

Note that characteristics of the present invention other than those described above are set forth in the following detailed description of the preferred embodiments.

### BRIEF DESCRIPTION OF THE DRAWINGS

FIG. 1 is a conceptual diagram of data searches;

FIG. 2 is a structural diagram of a data comparison operation processor;

FIG. 3 is a conceptual diagram of data comparison;

FIG. 4 is a specific example (Example 1) of the data comparison operation processor;

FIG. 5 is one example (Example 2) of a matrix (row and column) data transformation circuit;

FIG. 6 is one example (Example 3) of a comparison computing unit of the data comparison operation processor; and

FIG. 7 is one example (Example 4) of row-column (matrix) comparison operations on 100 million×100 million data items.

### DETAILED DESCRIPTION OF THE INVENTION

The preferred embodiment of the present invention will be described below in accordance with accompanying drawings.

### 1. ABOUT THE PRESENT INVENTION

The present invention has been developed based on the inventor's knowledge as below.

### (1) The Currently Fastest CPU

Firstly, the currently fastest CPU will be discussed in the following.

Currently, the fastest CPU on general-purpose personal computers (the fastest general-purpose CPUs) is the Intel® Core i7 Broadwell 10 Core, and its TDP (Thermal Design Power, i.e., the maximum power) is 140 W. Its specifications include 3.5 GHz (turbo) and 560 GFLOPS of floating-point operations per second, that is, it can perform 560 G calculations per second. Still this operation speed is too low.

On the other hand, the currently fastest CPU for special computers such as supercomputers (the fastest purpose-built CPUs) is the Intel® Xeon Phi™ 7290 (72 core), and its TDP (Thermal Design Power, i.e., the maximum power) is 260 W. Its specifications include 1.5 GHz (base) and 3.456 TFLOPS of floating-point operations per second, that is, it can perform 4 T calculations per second.

However, while being seven times faster than the general-purpose fast CPUs, the purpose-built fast CPUs are power-intensive, and their peripheral circuitry including onboard memories are complex, requiring a larger-scale cooling device, and therefore harder to utilize.

### (2) Performance of the Fastest CPU

One of the currently fastest GPUs is the NVIDIA® GeForce GTX TITAN Z. This GPU has 5760 cores, 375W of TDP, 705 Mhz single precision 8.12 TFLOP, that is, it can perform 8 T calculations per second.

The supercomputer, “K computer” consumes about 12 MW power and performs 10 quadrillion times of floating-point operations per second, that is, 10¹⁶ or 10 P operations per second.

However, the above GPUs also require significant power.

### (3) Benchmark for Evaluating the Present Invention

Computer performance is determined not only by CPU/GPU computation power, but also by various other conditions of the programs, OS, compiler used, such as the transmission speed of data needed for the CPU/GPU operations from an external memory to the CPU/GPU, the cache memory utilization rate for the data cached in the CPU/GPU, and the processing efficiency of multiple cores in the CPU/GPU, and therefore, depending on these conditions, the computer performance may be only several percent or less of the ideal performance of the CPU/GPU.

Thus, the CPU/GPU computation power is not the only factor governing the computer performance, but still is a key factor of the computer performance.

Accordingly, the CPU/GPU computation power is still the only benchmark indicator when comparing the novel computing technology of the present invention and the conventional computing performances.

However, CPUs are still continuously evolving towards higher performance. Since the performance of the architecture according to the present invention is based on the currently available semiconductor technology, it is understood that the semiconductor technology of the present invention will also improve proportionally to the progress of the state of the art.

### (4) Combinatorial Problems

Next, combinatorial problems, that the present invention is directed to, will be discussed.

Computers face many combinatorial problems and combinatorial explosions at various scales. Factorial explosions (big explosions) occur in optimization problems based on permutations and/or combinations, such as the travelling salesperson problem and the like as representative examples of the “NP hardness problem,” and there is a need for a new type of computer such as quantum computers. Also, there is a need in other combinatorial operations including comparisons among multiple data items although their explosions are not as large-scale as in the factorial operations (big explosions) in permutations and combinations.

The number of comparison operations for a combination of two data items is given by the product between one number of data items and another number of data items, wherein the maximum product is the square of the total number of data items. Therefore, in the case of big data, a small explosion may occur, causing extremely heavy load on processors of sequential processing type and inflicting a heavy burden such as long latency on users.

In the present invention is directed to the factorial operations (big explosions) of permutations and combinations, etc. and comparison operations there of, wherein such permutations and combinations are referred to as “exhaustive combinations” in order to differentiate them from the inter-data-item operations/comparisons (small explosions).

### (5) Concept of Data Search

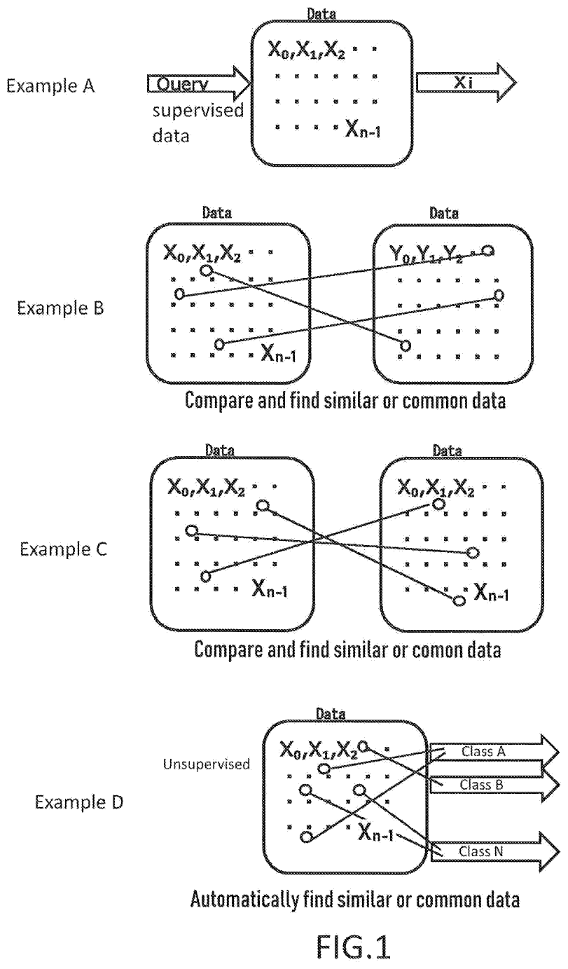

FIG. 1 shows a concept of data search.

The Example A of FIG. 1 is a conceptual diagram of a case where a certain data item is being searched among n data items, X₀-Xₙ₋₁.

This example shows a concept of search for a specific data item Xi (of interest) among a set of data items by providing a key or a search criterion as a query in order to find the specific data item.

Common searches, full-text searches or database searches all employ this type of search method.

Since the search cost increases as the amount of data increases and the search criterion becomes more complex, indices and the like are generally prepared before executing the searches even for such relatively simple searches.

This index technology is essential to searching, but it has various side effects (one example being data maintenance or the like) to undesirably enlarge the system of the von Neumann-architecture computers although ideally the indices would be eliminated for faster searches.

The above Example A is the case when what needs to be searched for is clear.

The content-addressable memories (CAMs) are the very devices for such a search type as above; wherein the CAMs are used to search or detect specific data among big data using parallel operations, but the CAMs have been only utilized for searching unique data such as IP searches for the Internet communication routers due to their shortcomings including the inflexibility limited to searches with one criterion up to three-value criteria (TCAM), low performance in multi-match processing, and high search rush currents to making the CAMs uneasy to use.

Also, in one of the problems in utilizing big data, the optimal question or query is indeterminable for unknown set of data, and therefore, often exhaustive combinatory searches must be performed repeatedly.

Further, the query shown in the above Example A represents a teaching signal in the field of artificial intelligence (AI).

In the cases of, for example, unknown data, for which the question to ask is also unknown as described above, there exists a need for a method for automatically enabling searches for required information and classification without providing sequential queries (no training), as further discussed in the following.

### (6) Searches Used in Data Analyses Such as Data Mining

Searches used in data analyses such as data mining will be discussed below.

Example B shows a concept of exhaustive combinatory search for similar (including matching) and/or common data items among n data items of X and m data items of Y.

As an example, X may be a data set of nonessential grocery items for men (data of some favorite food items, etc.) and Y may be a data set of nonessential grocery items for women (data of some favorite food items, etc.), wherein similarity and/or commonality between these two data sets are searched exhaustively and combinatorially.

If both data sets are unknown, (n−1)×(m−1) times of comparison operations need to be performed between the data set. Since n>>1 and m>>1 normally, we express this as n×m times of comparison operations.

When n or m is large, the combinatorial explosion occurs.

Example C shows a search for similar (including matching) and/or common data items among n data items of X.

In this figure, comparisons of X₀-X₀, X₁-X₁, . . . , Xₙ₋₁-Xₙ₋₁ are ones between identical data items, respectively, and therefore, a symbol indicating commonality is not shown for those data item pairs. This figure shows a search for similar and/or common data items excluding comparison between such identical data item pairs.

For unknown data, n×n times of comparison operations need to be repeated exhaustively and combinatorially between the identical data set as discussed in the following.

Example D is a schematic diagram of classifying similar and/or common data from n data items. If there are N data items which are similar and/or common, n×N times of exhaustive combinatorial comparison operations need to be executed.

Particularly in fields of data analysis and the like, when the data is unknown, there is a need for means for classifying data automatically at a high speed without preprocessing such as providing training data (queries) and/or learning.

Information processing will progress significantly if searches such as ones in Examples B, C and D described above may be achieved using a single device as in the content-addressable memory (CAM) and with higher performance.

### (7) Applications of Exhaustive Combinatorial Comparison Operations

Applications of exhaustive combinatorial comparison operations will be discussed below.

One of the representative example of the exhaustive searches is seen in genetics research, where substantial manpower and high-performance computers have been fully used to elucidate various genetic (genomic) information.

The genomic information discovered so far is still the tip of iceberg and more exhaustive analyses will be needed, for example, for predicting carcinogenicity based on analyses of individual genomic information.

Also, IT drug discovery research to efficiently enable drug discovery requires exhaustive pattern matching in areas such as 3D structural analyses of proteins, where supercomputers and/or high-performance CPUs/GPUs are used.

Being close to our everyday life, a weather forecast, including the atmospheric temperature, the atmospheric pressure and the wind direction, is influenced complexly by atmospheric and oceanic conditions affected by a wide variety of factors such as the sunspots, the Earth's revolutionary orbit and distance from the Sun, the Earth's axial change due to its rotation, change factors of the Earth itself, etc., wherein in order to predict tomorrow's weather, the above factors need to be chronologically analyzed using an exhaustive (combinatorial) comparison analysis based on historical data and various conditions, but the combinatorial explosion occurs as the number of combinations increases.

Also, representative of economic indicators, a stock price fluctuates depending on a wide variety of factors including the corporate performance, the exchange rate, politics, social trends, etc., wherein in order to predict the future stock price by analyzing the above factors chronologically, exhaustive (combinatorial) comparison analysis involving practically infinite calculations is essential, causing the combinatorial explosion with a large number of combinations.

For example, when a supermarket or a convenient store predicts their purchase orders for tomorrow, historical data, incorporating a large number of fluctuation factors such as the above-mentioned season and weather as well as the economical conditions, need to be exhaustively and combinatorially analyzed.

When searching through a vast number of social media and/or web sites and pages, a large number of accesses may occur within the same time period, and a search result needs to be outputted for each access within a limited amount of time (with realtime processing).

For example, if it is assumed that a half of the world population of 8 billion, i.e., 4 billion people access a particular search engine 10 times a day on average, the total daily number of accesses will be 40 G times.

This access volume is equivalent to 266 K times of accesses per second.

Such multiple accesses in super high volume inevitably entail exhaustive combinatorial searches similar to Example B of FIG. 1 whether or not it is recognized.

As discussed above, the need for exhaustive comparison operations exists in a variety of forms being obvious or unrecognized, but the exhaustive comparison operations are not utilized except in special applications even when vast number of time-consuming calculations are required for existing data.

Also, Web search systems for big data with multiple accesses being unavoidable have to become extremely large-scale systems.

As another example of combinatorial and/or exhaustive comparison operations, a relatively simple and commonly seen example will be discussed below.

Now, we consider processing for searching full names (sets of last and first names) each having a plurality occurrences among the Japanese population of 100 million.

Here, the (last and first) names of 100 million people are totally unknown, and when performing brute force comparisons (exhaustively and combinatorially) as shown Example C in FIG. 1, the required number of comparison calculations will be 100 M (=10⁸)×100 M (=10⁸)=10 P (=10¹⁶).

Such comparison operations will require tens of thousands of seconds using the latest and fastest CPU, and several seconds even using the cutting-edge supercomputer, K computer.

Moreover, if the population becomes a billion, the number of the comparison operations will be multiplied by 100, making this comparison processing un-attainable realtime even with the fastest CPUs.

In the above, the example of combinatorial comparison operations was discussed, wherein the number of combinations, being a square of the data size, grows exponentially as the data grows larger, thus causing the combinatorial explosion of comparison operations to pose an obstacle in the data analysis field.

The present invention has been devised by the present inventor in light of the solution challenges discussed above.

### 2. ONE EMBODIMENT OF THE INVENTION

One embodiment of the present invention will be described below.

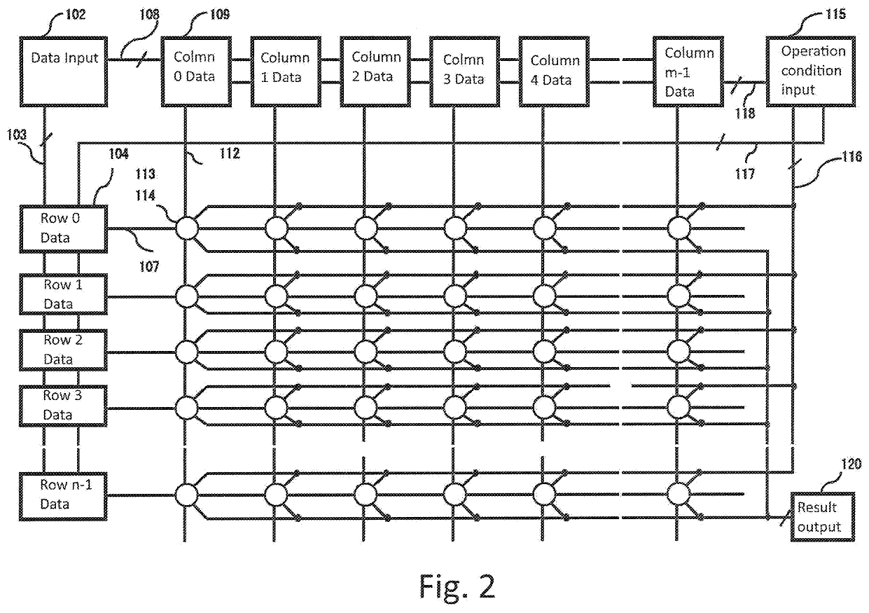

FIG. 2 shows an example configuration of a data comparison operation processor 101 according to one embodiment of the present invention.

The data comparison operation processor 101 (hereafter, sometimes simply referred to as a “present processor 101”) receives data transmitted from an external memory via a data input 102, wherein row data 104 is entered through a row data input line 103 into n row data memories from Row 0 through Row n−1, whereas column data 109 is entered through a column data input line 108 into m column data memories from Column 0 through Column m−1 to thereby store data required for exhaustive and combinatorial parallel comparison operations.

As in above, from the total n+m memory data items 104 and 109, consisting of the n row data memories and the m column data memories, row data operation data lines 107 and column data operation data lines 112 are respectively wired in a mesh pattern, wherein a computing unit 113 or a comparison computing unit 114 is provided at each cross points (intersections) of the row and column data line wiring, wherein all computing units 113 and 114 are configured to received data parallelly from the respective rows and columns, and wherein n×m computing units 113 and 114 are configured to be capable of operating data of n rows and m columns exhaustively and combinatorially.

The computing units 113 may be common ALUs or other computing units, and the comparison computing units 114 will be discussed later.

Also, the computing units 113 and 114 receive computing unit conditions 116 externally entered and specified, and are connected to an operation result output 120 for externally outputting operation results.

With the above configuration, SIMD (single instruction multiple data) comparison operations may be achieved between data items from one row and one column for all rows and columns parallelly and combinatorially.

When the computing units are ALUs (Arithmetic and Logic Units), the row data operation data lines 107 and the column data operation data lines 112 become multi-bit data lines, forming a configuration for parallelly executing SIMD-specified comparison logic operations and outputting their comparison operation results.

Exhaustive combinatorial comparison operations are often needed in the big data area, as shown in FIG. 1, where the number of data items is extremely large, and although it is desirable to perform exhaustive combinatorial operations using many computing units, the number of cores enabled to handle big data is very difficult to achieve using ALU-based computing units such as CPUs and/or GPUs because even the most advanced GPUs currently available are only equipped with up to 5,760 cores as discussed above.

The present inventor has been conducting research and development of products for faster information search with built-in micro-computing units. Among those products, SOP (registered trademark of the present corporation) is a device mainly for image recognition, and DBP (registered trademark of the present corporation) is a device for searching information in databases, etc. Thus, the present inventor has been developing products in various fields to thereby verify the validity of the present technology.

The common technology among the products discussed above is a 1-bit computing unit, which is a micro-computing element.

For details, see Japanese Patent Application No. 2013-264763.

Discussed below are example applications capable of utilizing the row-column (matrix) comparison operations described above in the most effective way, and a method for performing combinatorial parallel comparison operations using the comparison computing units 114 based on 1-bit computing units, wherein the comparison computing units 114 are highly integrated, computationally efficient and suited for searching data match and/or similarity.

Essential operations in performing comparison operations 154 on data are common 137 operations determined as match 132, mismatch 133, similarity 134, large/small 135, range 136 or any combination thereof.

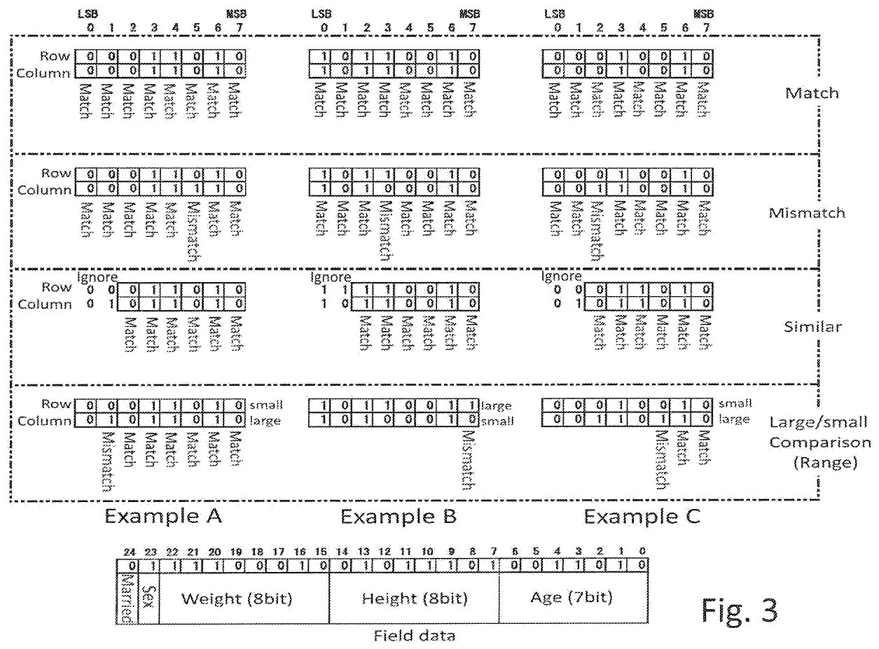

FIG. 3 is a conceptual diagram of data comparison 131 summarizing the above discussion.

In the present example, three examples, Example A, Example B and Example C, are shown for the above-discussed match, mismatch, similarity, and large/small or range, respectively, for 8-bit data items with the MSB (Most Significant Bit) through the LSB (Least Significant Bit).

In the case of match 132, all column and row bits match, respectively. In the case of mismatch 133, if at least one column-row bit pair of the 8-bit data items don't match, the pair of two entire data items are determined to be mismatched.

The determination of similarity 134, where values of two data items compared are close, are enabled by ignoring a number of bits on the LSB side and comparing the rest of the data bits.

For BCD data, this determination is enabled by ignoring some last digits of decimal data during the comparison.

Also, the large/small 135 comparison between data items may be enabled by determining which of the row or column has the value 1 for the mismatched bit pair closest to the MSB.

Data item which passed both the two comparisons, “large” and “small” passes the range 136 comparison.

Also, the common 137 determination may be performed by combining the above.

The above is merely an example of operations. Data comparison operations make up a large fraction in the entire computing, and they are essential to big data analyses in particular.

As shown in the lower part of the figure, when there are a plurality of field data items to be compared, those field data items may be connected and different operation conditions are set for respective field data items.

For example, when a database has five field data items, such as Age, Height, Weight, Sex and Married/Single, total of 25 bits may be assigned to 7 bits for Age (max. 128 years old), 8 bits for Height (max. 256 cm), 8 bits for Weight (max. 256 kg), 1 bit for Sex (Male/Female) and 1 bit for Married/Single (Married/Single), wherein an operation condition is set for each field and comparison operations 154 may be repeated 25 times for each of the 25 bits, as will be described in detail below.

When defining an 1-bit-based operation described above as “1 clock operation,” an operation for each field as “1 field operation,” and an operation for the fields of interest as “1-batch operation,” the present example has five fields, and therefore, its 1-batch operation has 25 clock operations.

Thus, if all data items have respectively identical data formatting as in the common information processing, data comparison 131 for data consisting of any number of bits and any number of fields may be achieved by repeating the row-column comparison operations (matrix comparison operations) individually for each bit of the rows and columns to thereby enable the SIMD (single instruction multiple data)-type operations using the same operation specification.

In this method in other words, instead of individually comparing each pair of data items using a CPU or GPU, all computing units may perform comparison processing in parallel under only one command, making this method suitable for enabling super-parallel comparison operations as a foundation of the present invention.

Also, unlike ALUs, in which the data width (operand width) is fixed to a certain length such as 32 bits or 64 bits, the computing units of the present invention are not of fixed data width, and allows assignment of data onto memory cells without wasting any memory cells to thereby improve the memory and operation efficiencies.

In other words, the present invention may implement an LSI with super-parallelized comparison computing units 114, each with an extremely simple configuration, as discussed below.

Further, it is characteristic that extremely efficient calculations are possible by transmitting a large amount of data in advance, as in CPU cache memories. This is essential in order to utilize these computing units without wasting their performance, as will be discussed later.

### 3. EMBODIMENT EXAMPLES

### Example 1

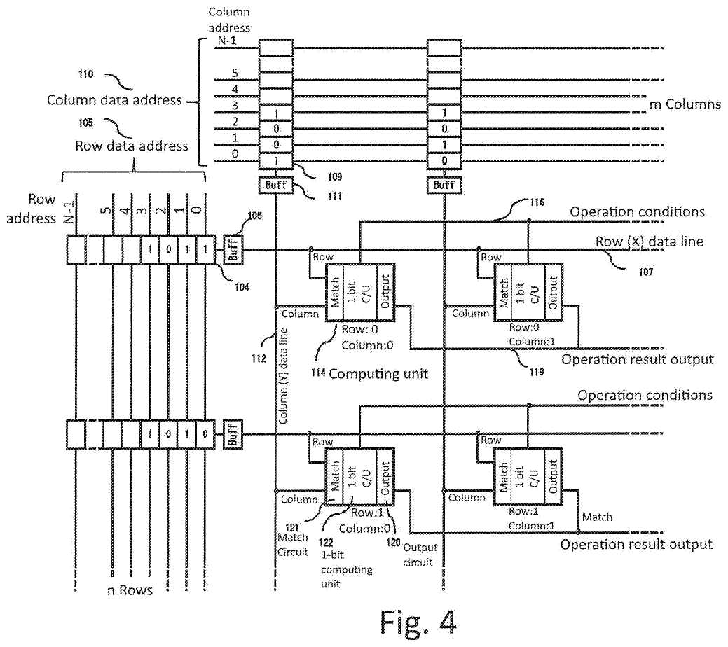

FIG. 4 describes the structure of the data comparison operation processor 101 using the comparison computing units 114 described above more specifically.

As shown in the figure, data items 104 and 109 consisting of n data items per row and m data items per column, respectively, are configured to be connected exhaustively and combinatorially to the n×m comparison computing units 114 to thereby enable parallel comparison operations.

The row direction memory data items 104 are processed with matrix transformation as row direction data items as described below, and are configured to allow n accesses (selections) in parallel for each memory cell at respective row data addresses 105, wherein a data item of a memory cell at an accessed address is entered in a row data buffer 106, and wherein outputs from the row data buffers 106 are entered in parallel to row inputs of match circuits of the comparison computing units 114 in the row direction.

In other words, in this example, when Row Address 0 is accessed, as row inputs, “1” is entered into the comparison computing units 114 of Row 0, Column 0 and Row 0, Column 1, and “0” is entered into the comparison computing units 114 of Row 1, Column 0 and Row 1, Column 1.

Although not illustrated, data will be entered into rows of the comparison computing units 114 in a combinational manner of n rows and m columns.

Similarly, data is entered into the column direction, wherein in this example, when Column Address 0 is accessed, as column inputs, “1” is entered into the comparison computing units 114 of Row 0, Column 0 and Row 0, Column 1.

Also, “0” is entered into the comparison computing units 114 of Row 1, Column 0 and Row 1, Column 1.

Although not illustrated, data will be entered into columns of the comparison computing units 114 in a combinational manner of n rows and m columns.

In this example, since each of both rows and columns has 4 bits, both rows and columns send data of their respective Address 0 through Address 3 in sequence to the comparison computing units 114 to thereby allow the comparison computing units 114 to execute required comparison operations between row data and column data.

In case of searching for matches, the comparison computing unit 114 of Row 1, Column 1 will output a match address 119 from the operation result output 120 because at this comparison computing unit 114, the 4-bit row and column data items are identically “0101” in the present example.

In the above discussion one set of 4-bit data items were compared, but even when there are a plurality of data of, for example, Age, Sex, Height, Weight, etc. with respective data width ranging from 1 bit to 64 bits or any longer length, any number of sets of matrix (row and column) data may be allocated and utilized.

As will be further discussed later, a plurality of batches of data may be entered with each batch having n×m data items, and comparison operations may be repeated successively for the plurality of batches.

At a glance, 1-bit-based comparison operations may seem inefficient, but the operational effectiveness of this scheme will be discussed later.

Also, if matrix data adders are incorporated into the present circuitry to execute 1-bit-based operations, adding and subtracting operations are enabled as well.

When externally receiving matrix (row and column) data, if a data matrix transformation circuit is provided right after the data input 102 of the present processor 101 the need to perform the data matrix transformation is eliminated on the HOST side to improve the efficiency of the entire system.

### Example 2

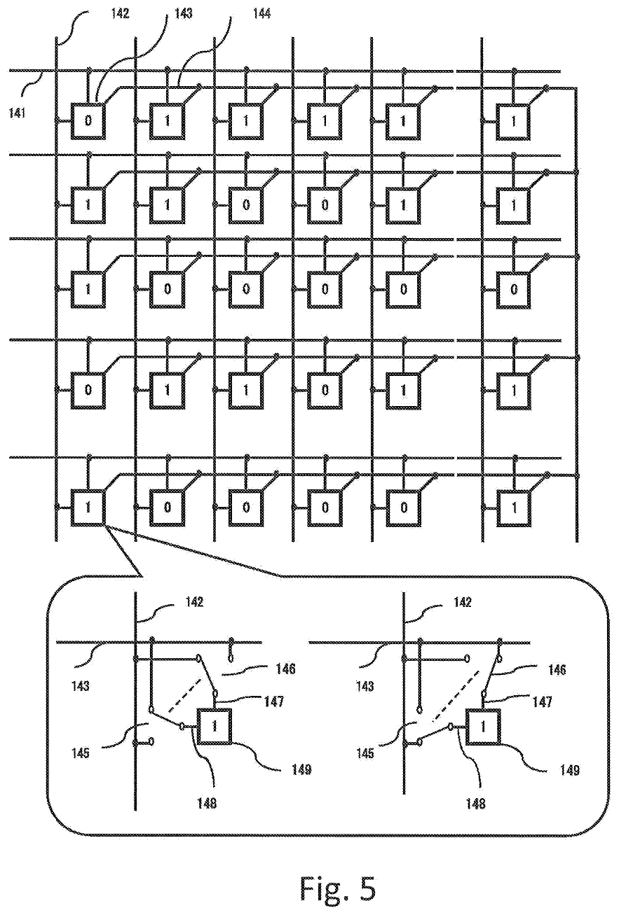

FIG. 5 is an example of matrix (row and column) data transformation circuit.

As shown in the lower part of the figure, memory cells 149 are configured to output data from their respective memory cell data lines (bit lines) 148 in response to their respective memory cell address selection lines 147 being selected.

The present scheme transforms or switches the row and column directions by connecting a matrix transformation switch 1 and a matrix transformation switch 2 to each of the memory cells to thereby swap switches 145 and 146.

In this configuration, address selection lines 141 are switched with data lines (bit lines) 142 by respective matrix transformation signals 144.

By utilizing this transformation circuit, external data, such as with 64-bit configuration, entered in a row sequence may be converted to 64-bit data in a column sequence. With two such circuits, external data may be continuously imported into the present LSI to thereby create row data 104 and column data 109.

Although not limited to this transformation circuit, HOST-side load is reduced with a built-in matrix transformation circuit or matrix transformation circuits.

### Example 3

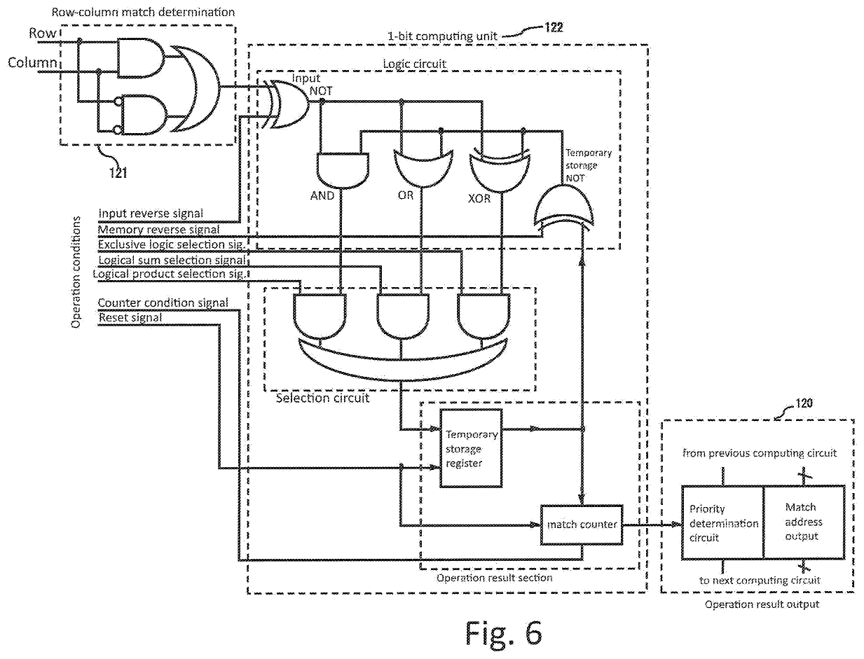

FIG. 6 shows an exemplary embodiment of a comparison computing unit 114 of a data comparison operation processor 101.

This comparison computing unit 114 is, as described above using FIG. 4, composed of a row-column match circuit 121, a 1-bit computing unit 122 and an operation result output 120.

The row-column match determination circuit 121 is a circuit for comparing to determine whether a row data item and a column data item, respectively given bit by bit, do or do not match.

It is composed of logical product (AND) circuits, NAND circuits and/or logical sum (OR) circuits.

The 1-bit computing unit 122 is composed of logic circuits and their selection circuits as well as an operation result section to execute comparison operations such as for the 1-bit-based match, mismatch, similarity, large/small and range, shown in FIG. 3.

It is configured to operate data determined at the row-column match determination circuit 121 and data stored in a temporary storage register with logical product, logical sum, exclusive logic and logical negation based on operation conditions so that a temporary storage register 127 and a number-of-matches counter 128 which survived predetermined operations will be those of match addresses 119.

For example, in the case of 8-bit data, by processing matrix data entered on a 1 bit basis under specified operating conditions up to eight times, comparison operations 154 for match, mismatch, similarity and large/small comparisons of the matrix data may be enabled.

Also, in the case of operations such as ones for determining the number of matches for a plurality of data such as Age, Sex, Weight, Height, etc., the number-of-matches counter may be utilized to determine if the number of matches reached a predetermined count value or more.

This comparison computing unit 114 is characterized in that there is no need for circuits for four arithmetic operations such as adders, which upscale the circuit size.

In this example, in order to operate on data with any number of bits or any number of fields, the operation result section is configured to allow determination for any number of bits using the register for temporality storing row-column match determination results for 1-bit-based data, and determination for any number of fields using the number-of-matches counter for storing the number of matches for data columns.

The operation result output 120 is composed of a priority determination circuit 129 and a match address output 130.

This configuration is in order to output X-Y coordinates (addresses) of the match addresses in descending order from a computing unit of the most significant byte when a plurality of computing units had a match as a result of one batch of operations, and to externally send the coordinates (addresses) of the match addresses 119 preferentially starting from the computing unit of the most significant byte as the operation result through the operation result output 120.

### 4. ASIC OF THE PRESENT EMBODIMENT

Next, an actual ASIC example of the present processor 101 will be specifically discussed.

When considering the present processor 101, at least the following need to be determined:

1. Scale and nature of data in question, and specific operations needed for combinatorial parallel operations;
2. Configuration of computing units and the number of operations per unit time;
3. The number of on-chip computing units (parallelism);
4. Data transfer performance from an external memory (data supply performance);
5. Capacities of an internal memory and a cache memory;
6. Output performance of operation result data;
7. Potential bottleneck(s), and overall computing performance;
8. The number of LSI pins; and
9. Power consumption and heat generation.

The above items need to be comprehensively determined.

In the current semiconductor technology, 10 billion or more transistors may be implemented on one chip.

The circuit configuration of the present processor 101 is exceptionally simple and one comparison computing unit 114 with an output circuit may be realized with only about 100 gates and about 400 transistors.

For example, in order to implement 16 million (16 M) comparison computing units 114 using many of on-chip transistors today, 16 M×400 transistors=6.4 billion transistors will be required.

16 M is equivalent to 4K rows×4K columns; that is, 16 million comparison computing units 114 (processors) perform the comparison operations in parallel (simultaneously).

It is desirable to keep power consumption of the present processor 101 equal to 10 W or less, i.e., in the power range not requiring a cooling fan, and to achieve a configuration with general-purpose, fast computing units.

Since power consumption increases significantly over 1 GHz of system clock, the considered system clock needs to be 1 GHz (1 nanosecond clock) or less.

A basic structure of the present processor 101 will be summarized in the following based on an actual embodiment example.

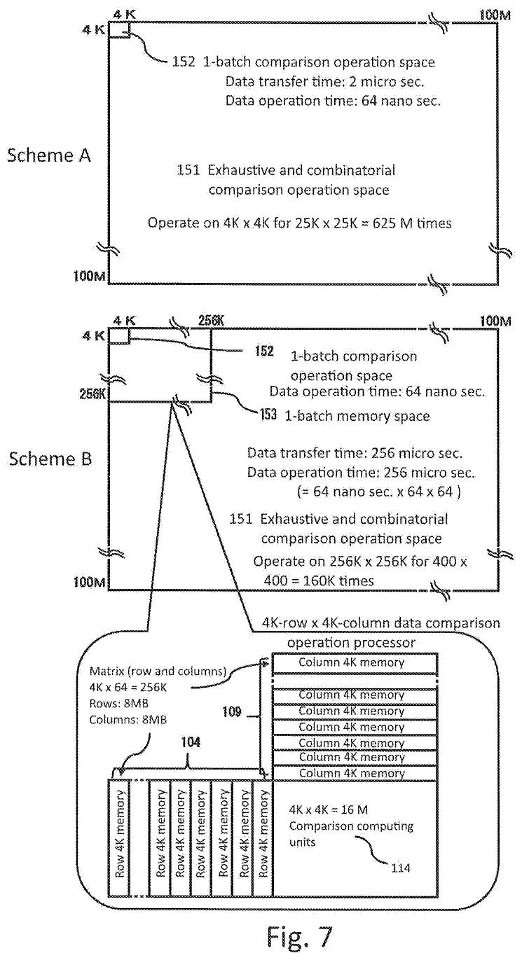

FIG. 7 shows an embodiment example of row-column (matrix) comparison operations on 100 million×100 million data items with the present processor 101 using the above 4 K×4 K comparison computing units 114.

In order to simplify the description, it is assumed that the data size is 100 million (100 M), and people having identical full names (last and first names) are searched exhaustively and combinatorially in a matrix with its rows and columns having the same data, as shown with Example C in FIG. 1, wherein each of the names is a 4-character data item, i.e., a 4-field data item such as “ [symbol] ” consisting of 4 kanji characters.

Since this comparison computing circuit 114 will iterate 1-clock operation for every 1 bit, kanji data of 4 characters=4 fields (16 bits×4=64 bits) will be operated over 64 times at 1 clock operation per 1 nanosecond, in other words, 1 batch of comparison operations takes 64 nanoseconds.

This is the operation time required for 1 batch of comparison operation space 152 of the 4K×4K=16 million computing units as a whole.

Next, data input time for transferring data from an external memory to the present processor 101 will be discussed.

Data transfer rate for common DDR memory modules is about 16 GB/second.

If it is assumed that the time needed for transferring the data of 4 K rows×64 bits (8 B) at 16 GB/sec is obtained by (4 K×8 B=32 KB)/16 GB=2 microseconds, and similarly, the time required for transferring the data for the columns is 2 microseconds. This 2 microseconds of time length is referred to as 1 data transfer time.

As shown in Scheme A in FIG. 7, when executing 100 M×100 M of combinatory comparison operations in a comparison operation space with 1 batch having 4 K×4 K, a total of 25 K×25 K=625 M times of exhaustive comparison operations need to be repeated as in a raster scan.

For example, with one row data item being fixed and the column data items being switched, 25 K times of comparison operations are performed, and therefore, the number of data transfer is (1+25 K)×25 K 625 M times, and the data transfer time in the entire combinatorial comparison operations space is 625 M times of 1 data transfer time, i.e., 2 microseconds×625 M=1,250 seconds.

The above method for utilizing the present processor 101 produces results compromising the present technology's effectiveness since the overall data transfer time becomes extremely long compared to the 64-nanosecond comparison operation time of 4 K×4 K of 1-batch operation space 152 as shown above.

### 5. COMPARISON OPERATION METHOD OF THE PRESENT EMBODIMENT

A comparison operation method for maximizing the effectiveness of the present technology will be discussed below and illustrated with Scheme B of FIG. 7.

In the previous discussion, 1 batch of data in 4 K rows and 4 K columns was transferred when it is needed, but now as an example, 64 times of 4 K data, i.e., matrix data of 256 K in rows+256 K in columns, is transferred as data of 1-batch memory space 153, and the time required to transfer the data of the 1-batch memory space 153 will be considered.

The amount of data in rows and columns of the 1-batch memory space 153 is obtained by (4 K+4 K)×8B×64=4 MB.

Therefore, the data transfer time for the 1-batch memory space 153 is 4 MB/16 GB=256 microseconds.

On the other hand, as for the comparison operation time, since 1-batch operations of 4 K×4 K may be achieved in 64 nanoseconds, overall operations for the 1-batch memory space 153 may be achieved by repeating the comparison operations as in the raster scan, where 256 K/4 K=64 times of 1-batch operations is required for rows and columns, respectively; and in total 64 times×64 times=4 K times of 1-batch operations is required.

In this case, data needed for computing a matrix of “64×64” is received as the data of a matrix of “64+64” in advance, and as previously discussed in reference with FIG. 4, the present processor 101 may be able to sequentially utilize this data to thereby enable the processing with the operation time of 64 nanoseconds×4 K times 256 microseconds.

In other words, the operation time becomes the same as the data transfer time, realizing a well-balanced performance as well as enabling independent transfer of predetermined unit of data during operations, except for the initial operations. This hides apparent data transfer time under the comparison operation time to thereby enable computing on 256 K×256 K of the 1-batch memory space in 256 microseconds of comparison operation time.

As discussed above, in this method, a large amount of matrix data is transferred in advance as in a CPU cache memory to allow continuous repetition of operations, wherein as the most important characteristic of this technology, the entire data may be transferred by sending two sets of “4 K data×64 times,” i.e., sending 4 K data 64+64=128 times, whereas the number of operations needed is 64×64=4096 times (4 K times).

Data transfer time is proportional to the data volume, whereas the number of combinatorial operations is proportional to the square of the data volume, and therefore, the present technology allows to take full advantage of the merits of advance data transfer and cache memory.

The effect of this scheme is called “advance data read effect.”

Note that if the 4 MB memory previously shown is configured with a SRAM, with each cell having 6 transistors, the total number of transistors is 4 M×8×6≈200 million. By further adding memories as needed, a variety of additional operational effect may be achieved.

By repeating the 256 K×256 K of the 1-batch memory space 153 by additional 400 times×400 times=160 K times, operations on 100 million (10⁸)×100 million (10⁸)=10 quadrillion (10¹⁶) of the entire spaces will be completed, and the time required for the entire exhaustive and combinatorial operation space 151 will be 62 microseconds×160 K times≈42 seconds.

As will be discussed below, the above time length does not consider idle time, comparison operation instruction time and comparison operation result output time, but its number will be referred as “100 million total processing time” for now.

It is possible to use multi-bit computing units such as ALUs to speed up the 1-batch comparison operations, but since the data transfer time will become a bottleneck, it is meaningless to speed up the 1-batch comparison operations.

When combinatory operations are limited to comparisons, the best practice is to repeat the 1-bit-based operations as in the comparison computing unit 114 of the present example in order to achieve a good balance between the data transfer time and the operation time.

Also, for ALUs, a data width is fixed, reducing the memory efficiency and/or operation efficiency, whereas the present scheme accommodates any data width of 1 bit or more without wasting any computing resources to thereby enable exceptionally efficient parallel operations.

Unlike CPUs and/or GPUs, the present processor 101 is not driven through programs, but each of its computing elements performs fully identical SIMD-type operations, thus enabling full elimination of wasted resources and overhead time of each computing unit to thereby eliminate the need to consider idle time.

### 6. OPERATION INSTRUCTIONS OF THE PRESENT EMBODIMENT

Operation instructions of the present processor 101 will be discussed below.

Now, an example of setting operation conditions will be shown for comparing multi-field matrix (row and column) data such as Age/Height/Weight discussed in reference with FIG. 3.

Individual operation expression for the row-column comparisons for match of Age data (0-6): (0-6) row=column

Individual operation expression for the row-column comparisons for similarity of Height data (7-14): (7-14) row≈column
Individual operation expression for the row-column comparisons for large/small of Weight data (16-22): (16-22) row>column
Individual operation expression for the row-column comparisons for match of Sex data (23): (23) row=column
Individual operation expression for ignoring Married data (24): no operation expression required

As above, a comparison operation condition and a comparison operation symbol are determined for respective row and column data items as individual operation expressions for each of fields in question.

Although further details are omitted here, additional conditions need to be determined in more detail, including whether the data format is binary or BCD or text, or which data is to be ignored when searching for similarity.

Moreover, individual field operations on in-field-data may be performed with the temporary storage register of the comparison computing unit 114 shown in FIG. 6 so that the overall comparison operations of individual field operation expressions discussed above may be externally provided as comparison operation expressions such as [(0-6) row=column]×[(7-14) row column]×[(16-22) row>column]×[(23) row=column] to achieve predetermined row-column comparisons within the present processor 101; whereas a specified operation condition circuit may be configured so that overall multi-field operations may be used to enable counting operations at the number-of-matches counter 128.

Needless to say, any logic combination such as logical product, logical sum, exclusive logic, logical negation, etc. are possible for both the operations within individual fields and the overall multi-field operations.

Typically, operation instructions to the present processor 101 are sent from a computer on the HOST side through PCIe and/or a local network.

The comparison operation instruction time is negligible in comparison to total processing time even with the assumption that the time required to send the 1-bit-based comparison operation conditions is in the order of several tens of microseconds to several milliseconds since once comparison operation conditions are specified at the beginning of comparison operations, the same comparison operation conditions may be implemented every time even in vast combinatorial comparison operations discussed above, and therefore.

### 7. COMPARISON OPERATION RESULT OUTPUT OF THE PRESENT EMBODIMENT

Lastly, output of the comparison operation results of the present processor 101 will be described. Whether there are many computing units with matching row-column pairs (match addresses) or not within the 1-batch comparison operation space significantly affects the total processing time.

In this example, match probability and output time will be discussed for the case of searching for full names each having a plurality of occurrences among Japanese people, as previously shown.

Since there are supposedly 13 million kinds of full names each having multiple occurrences among the Japanese population of 120 million, one full name has 10 matches on average (average probability is 10). It means that among combinatorial comparisons of 100 million×100 million, 1 billion match addresses will be detected.

In association with this match address data, there is a need to output area data for indicating which areas these match addresses belong to in the 100 M×100 M combinatorial space, at least once for each area.

The HOST side, which receives the match address data, may determine where those match addresses are located using the area data and the above-discussed 4 K×4 K match addresses.

Since 1 data item, and a pair of row (X) and column (Y) are each 2 B in size and 4 B combined, time needed to externally output the match addresses 1 billion times (1 G times) takes 1 G times×1 nanosecond=1 second, considering 1 clock of external output takes 1 nanosecond.

The data size for the above output is 1G×4B=4 GB.

If the average probability is 10 times of the above, the external output time will be 10 seconds, but since this output may be performed independently of the comparison operations, the previously shown “100 million total processing time” of 42 seconds will not be affected if the scale-up is up to several tens of times.

Next, a case where the occurrence frequency is high will be discussed.

For example, when matches are detected on average 10 thousand times (10 K times) for each of the 100 million data items, the external output time will be 1000 seconds.

At the same time, memory space of as much as 100 M×10 K×4 B=4 TB will be required at the computer on the HOST side, and one should note that additional time will be needed to further organize the extracted 4 TB of data by a CPU.

Thus, when conducting a combinatorial search between big data, such a search should not be done in a way to blindly look for ubiquitous objects such as water and air among big data, but rather, limited combinations should be searched for as one would search for gold or diamond.

Needless to say, the discussion regarding the above operation result data similarly applies to cases where typical combinatorial searches are conducted using CPUs.

Now, the overall picture of present processor 101 discussed above will be shown with an image of a small factory.

This factory is equipped with very many super-compact, high-performance data processing machines in every single space therein with no missed space.

A truck brings in 2 sets of data items into this factory's entrance, and as soon as the respective data items enter the super-compact, high-performance data processing machines, data comparison operation processing is performed upon the data items in the machines all at once.

The super-compact, high-performance data processing machines completes the data processing at a super-high speed as if in a small explosion. Next, only their processing products, i.e., (important) data is output from the factory's exit and shipped by a truck. The image of the processor 101 is that the above factory processes are repeatedly performed at a super-high speed.

### 8. ADVANTAGE BENCHMARK OF THE PRESENT INVENTION

Based on the above discussion, advantages of the present technology will be benchmarked.

When using CPUs to conduct the present search for full names each having a plurality occurrences, if this search is conducted by average 4 steps per each comparison operation loop, such as by reading into a memory address, executing a comparison, reading the next memory address if there is no match, executing predetermined processing if there is a match, etc., using a general-purpose CPU capable of 560G times of operations per second, the time required to complete this search will be (100 million×100 million times)/560 G times=10 quadrillion/560 G times=71,428 seconds (about 200 hours), which is about 1,700 times longer than the “100 million total processing time” of 42 seconds.

The 42 seconds of “100 million total processing time” of the present scheme is a planned value, but an appropriately designed device will be able to operate with its theoretical values. When using a CPU, however, various factors contribute to its final performance, making it difficult to operate with its theoretical values, and in practice, its performance (time to complete the above search) difference is expected to be 3,000 times or greater.

Further, when a purpose-built fast CPU, capable of 4 T times of operations, performs one loop of comparison operations in 4 steps, the CPU will require 10,000 seconds (10 quadrillion times/1 T times), which is about 240 times longer than the “100 million total processing time” of 42 seconds.

In practice, the above performance difference is expected to be 500 times or greater.

Since the fastest GPUs' computing performance is about twice as fast as the purpose-built fast CPUs, even when comparing with the fastest GPUs, the performance difference is expected to be about 250 times.

Lastly, if the supercomputer, “K computer,” capable of 10 quadrillion times of operations per second, performs one loop of comparison operations in 4 steps, it requires 4 seconds to complete one operation loop.

Since “K computer” drives over 80 thousand CPUs in parallel, it consumes as much as 12 MW of power.

On the other hand, the present processor 101, which uses less than 10 W of power per chip and has about 1/10 comparison operation capability of that of “K computer,” has an advantage of over 100 thousand times higher power performance than that of “K computer.”

Thus, one chip of the present technology has comparison operation capability equivalent to those of common super computers.

To describe the above abilities using the factory example, this factory is small (the present processor 101 is only one semiconductor device), but has high productivity similar to that of a huge factory (a supercomputer), uses extremely low electrical power and common trucks (general-purpose data transfer circuits) for transporting its raw materials and products rather than special carriers such as ships and airplanes.

Needless to say, these performance differences come from the differences in operation architecture.

As previously noted, when CPUs and/or GPUs perform continuous comparisons between data items, they require several steps of comparison loop operations for each data item, such as reading into a memory address, executing a comparison, reading the next memory address if there is no match, flagging (FG) a memory work area if there is a match, etc.

When using the device performance used to evaluate CPUs and/or GPUs to express the operation performance of the present processor 101, its converted device performance may be expressed as 256 T times (0.25 P times)/sec of effective comparison operation performance because 16 M processors compute data of 64-bit width at a speed of 64 nanoseconds per 1 batch of comparison operation space 152.

The biggest difference between CPUs/GPUs and the present scheme is that, while CPUs/GPUs are improved serial processing-type multicore and manycore processors, the present scheme aims at super-parallelization from the start and the present processor 101 is specialized in comparison operations and dedicated to combinatorial operations.

The most advantageous point of the present invention is it focused on the following two synergetic effects that comparison operations may be SIMD-processed by 1-bit computing units capable of super-parallel processing, and that the number of operations of combinatorial comparison operations for given data is n×m and up to their squares. Only one of these two effects alone may not achieve the performance of the present invention.

### 9. APPLICATIONS OF THE PRESENT INVENTION

Applications of the present invention will be discussed below.

The above discussed combinatorial operations between data composed of 100 million×100 million=10 quadrillion (10¹⁶) of 8 B data items, but with similar data sizes and/or operation conditions,

combinatorial operations for various data amounts may be obtained proportionally, for example,
with 4.2 seconds, 10¹⁵ operations may be achieved (e.g., 1 million (10⁶)×1 billion (10⁹) combinatorial operations);
with 4.2 milliseconds, 10¹² operations may be achieved (e.g., 1 million (10⁶)×1 million (10⁶) combinatorial operations); and
with 4.2 microseconds, 10⁹ operations may be achieved (e.g., 10 thousand (10⁴)×100 thousand (10⁵) combinatorial operations).

Also, since the data length and the total processing time are in proportional relationship, when the data length increases by 4 times, the total processing time will also be multiplied by 4.

This comparison operation scheme may be utilized for data in large amounts and/or various data types as well as various data lengths.

The foregoing discussion is to show a rough idea of the performance of the present technology, and naturally, it is contemplated that the present technology enables applications in various information processing, which have been impossible for conventional information processing to achieve as the operation conditions become more complex, requiring more overwhelming comparison operation performance.

The aforementioned search for full names with multiple occurrences did not require exhaustive comparisons of field data, but an exhaustive and combinatorial operation method will be discussed in the following.

For example, one of the most needed data mining for aggregation of sales data of convenience stores and/or supermarkets is data mining for exhaustively detecting frequently-occurring combinations, such as combinations of items frequently bought together, e.g., “beer×edamame×tofu,” “wine×cheese×pizza,” “Japanese sake×“surume” (dried cuttlefish)×“oden” (fish dumplings and other ingredients in broth),” etc., and various techniques have been proposed.

One representative example of such techniques actively studied in recent years is the “MEET Operation,” but as the amount of data grows, the amount of computing increases explosively, leading to a very long waiting time unless various constraint conditions are given. Operations according to other techniques have very similar problems.

When detecting frequently-occurring combinations according to the present invention, field data of each product code (the same number of data items) may be switched and exhaustively operated on.

In the above example with 3 data items, total 9 times of combinatorial comparison operations 154 will enable the exhaustive combinatorial comparison operations.

In the case of 4 data items, total 16 times of combinatorial comparison operations 154 will enable the exhaustive combinatorial comparison operations.

The exhaustive combinatorial comparison operations of field data as above may be freely achieved by the number-of-matches counter 128 and its peripheral circuitry shown in FIG. 6.

The foregoing discussion showed that it is possible to conduct exhaustive combinatorial comparison operations of data fields, exhaustive combinatorial comparison operations between data with its data fields being fixed and exhaustive combinatorial comparison operations between those two.

Now representative examples of the present technology will be shown.

Extracted data items of the previously-discussed full names with multiple occurrences is, by themselves, indices.

Those extracted data items of full names with multiple occurrences may be utilized “as is” as indices. It used to be that complicated specialized technology was necessary to create indices, but the present processor 101 not only makes it easy to create indices, but also creates desirable indices at super-fast speed.

Of course, the present processor 101 may be utilized for indexing for data other than that of the present example.

This technology may be utilized as a data filter.

It may be used as in Example B of FIG. 1, wherein hypothetically, if filter conditions may be set (fixed) in X and data in question is given in Y, the filtering results may be extracted.

As discussed above, it is needless to say that the present technology is optimal for big data, but also it may process extremely large data in the order of microseconds or milliseconds to enable realtime processing applications.

Now realtime applications will be considered.

For big data of social networks, etc., data search using the KVS (Key-Value Store)-schema linking data keys (indices) and data is widely utilized.

Either one row or one column of the present processor 101 may be used as search index data, and the other may be used as multi-access search query data to perform comparison operations to thereby execute a multi-access search.

When using a device having the 4 K×4 K of 1-batch comparison operation space 152 and the 256 K×256 K of 1-batch memory space 153 previously illustrated to search, for example, indices with 64 bits per index of a social network website of a 100 million KVS-schema, the 1-batch memory space 153, each requiring 256 microseconds of operation time, may need to be operated on for vertical columns only 400 times, and therefore, the comparison operation time will be 100 million (the number of indices)×256 K (search data per unit) equaling about 100 milliseconds (0.1 second).

If the comparison operation time is 0.1 second, an extremely pleasant Web search system may be provided even with a communication time overhead included.

As previously shown, if a half of the world population of 8 billion, i.e., 4 billion people, access a specific social network search engine 10 times a day on average, for example, 40 G times of accesses occur per day, which is equivalent to 266 K times of multiple accesses per second.

Therefore, with the above operation performance of 256 K (search data per unit) per 100 milliseconds, the multiple accesses are processable even when it increases to 10 times thereof.

If there are N×100 million (10 billion) search sites, a super-compact, super-low-power and super-high performance search system is achieved using N (100) of the present processor 101.

Although the present example was based on the 256 K×256 K combinatorial operations as discussed above for convenience, more streamlined processing may be possible by designing the present processor 101 enabling optimal combinations according to the relationship between the number of data items (n) in question and the number of accesses per unit time (m) needless to say.

As an application of the above, since the present processor 101 allows setting variable data lengths and more complex search conditions, multiple accesses against a large volume of data are possible, as shown with Example B in FIG. 1.

This means that the present processor 101 may be utilized as a high-performance, content-addressable memory (CAM) equipped with various search functions.

While content-addressable memories (CAMs) eliminates the need for indices for searching and complex information processing, searching with flexible search conditions or multiple access are not their strength, and thus, they are only utilized for searching IP addresses (unique data) of communication routers today. The present processor 101 will significantly expand the applications of the CAMs.

The present processor 101 is optimal for cloud servers having a large amount of data and a high volume of accesses.

Since it allows comparisons for match, similarity, large/small and range of numerical data, either one of rows or columns may be configured fixedly with many filter condition values, and the other may be provided with a large amount of data to enable detection of matches. Such operations are optimal for equipment failure diagnostics, mining analyses of stock price fluctuations, etc.

Now, realtime analyses of text data will be considered.

Since the present invention allows fast exhaustive match detection for not only Western languages, but also the Japanese language, realtime mining detection of frequently-occurring words among vast data of social networks is considered to detect societal and/or market interests by mining.

In the previous case of full names with multiple occurrences, data items were 4 characters long, but since the data length is variable here, it may be applied to searches for patent publications and/or text data. Also, since a large volume of multiple accesses are possible according to the present invention, it is optimal for thesaurus (synonym) search.

AI technologies are increasingly receiving the public interest. Expectations for the AI technologies are diverse, but one may say that the objective is often to extract or sort required information without providing computers clear instructions.

For example, two of the most sought after AI technologies are Deep Learning for image and voice recognition, and clustering for self-organizing maps (SOMs) and support vector machine (SVM)

The previously-discussed search for full names with multiple occurrences was the data search such as Example C in FIG. 1, but from a different point of view, it is equivalent with automatically performing classification without special queries (training data) as in Example D. Compared to conventional technologies, this method, capable of performing various classifications only by changing the operation conditions, is extremely simple (no need for software) as well as super fast. The present processor 101 is the very example of information processing for such objective realized as one chip. Its applications are limitless from big data to realtime processing, and it may be described as new type of artificial intelligence.

Supplemental notes for the present technology will be provided below.

As Supplemental Note 1, we will discuss the case when the operation clock of 1 nanosecond described in the above example is changed to 5 nanoseconds.

In this case, the operation speed decreases to ⅕ of the original value, the 100 million total processing time will become 42 seconds×5≈210 seconds, but the power consumption may be significantly reduced.

As Supplemental Note 2, the case of changing the 4 K×4 K computing units to 1K×1K ones will be discussed.

In this case, since the number of operations increases by 16 times, the 100 million total processing time will become 41.9 seconds×16≈670 seconds, but a more compact chip may be realized at a lower cost.

The chip does not necessarily need to be in a square form, and may be 16K×1K, but it should be noted that the overall memory capacity will increase by (16+1)/(4+4)=2.125 times compared to the 4 K×4 K form.

As Supplemental Note 3, the case of the advance data read effect will be discussed.

If n=m, its effect is maximized.

Assuming n=m and the respective number of batches is K,

operation time=K²×1 batch operation time, and
data transfer time=(K+K)×1 data transfer time;
and therefore, an equilibrium point between the operation time and the data transfer time is obtained by the following formula.

K²×1 batch operation time=(K+K)×1 data transfer time K=2 data transfer time/1 batch operation time

The above K is the number of batches that will achieve the good balance.

In the previous example, that number of batches K was 64 and overall 4 MB of memory may enable the most efficient multi-batch processing operations, as discussed before.

If K is selected according to the operation time and the data transfer time, an optimal LSI may be achieved.

As Supplemental Note 4, an LSI with small capacity will be discussed.

The present processor 101 shown previously had a large capacity with 4 K×4 K matrix (rows and columns) and 16 M comparison computing units 114 for performing multi-batch processing in order to improve the operation efficiency.

The equilibrium point for this scheme is determined by the data transfer time and its total operation time for the multi-batch processing case.

For the present processor 101, the 1-batch comparison operation time is constantly 64 nanoseconds regardless of the number of comparison computing units 114; and now a data capacity for the data transfer time which achieves a good balance with this operation time will be obtained.

In this case, the data transfer time and the operation time for single-batch processing will be considered.

If the numbers of rows and columns are the same and the communication performance is 16 GB/sec as discussed above, and if the data size is 512 B+512 B, i.e., if 1 data item has 64 bits, the present processor 101 may be achieved with its rows and columns respectively having 64 data items and with 64×64=4 K comparison computing units 114.

When the number of data items is 64 or fewer, the data transfer time<<=operation time, thus achieving a good operation efficiency.

Although the performance is significantly decreased compared to the 4 K×4 K processor, it will be a low-cost processor with significantly higher power performance compared to that of conventional processors.

As Supplemental Note 5, when speeding up the comparison operation result output 120, the operation result format may be converted to FIFO (first in, first out) and the operation results may be communicated via fast serial communicating interface, for example, PCIe, to enable the ideal data communication value of 128 GB/sec.

Of course, the data transfer time may be improved for data for matrix comparison operations.

In the above, 2-dimensional matrices have been discussed, but a page concept may be included in the matrix to create a processor of 3-dimensional configuration for performing data transfer of n+m+o by n×m×o computing units.

As discussed above, optimal chips may be designed in consideration of particular objectives and/or performance. FPGAs may be utilized if they are of capacities for small-scale processing.

### INDUSTRIAL APPLICABILITY

In recent computing, it is essential that CPUs have many on-chip cache memories and effectively utilize those cache memories to improve the overall system efficiency, but there is a limit to how much such a improvement may be achieved with the conventional architecture.

The present invention provides the operation architecture achieving the most efficient memories and processors by limiting the scope of computing to comparison operations without needlessly building on the conventional technology.

Currently, data comparison operations are utilized in very limited areas. That is because the current computer architecture leads to very long latency due to the large volume of computing required for the comparison operations, and heavy load on program development for reducing the computing time.

In the following, the needs, including the potential ones, for the present processor technology will be summarized.

Explicit and potential needs for the exhaustive and combinatorial comparison operations:

### (1) Combinatorial Problems

(a) Characteristic data need to be searched among a large volume of data such as genetic information.
(b) Rare data such as the full names with multiple occurrences need to be searched among a large data population.
(c) Sorting and classification of data including duplicates, such as aggregation of names, needs to be done.
(d) Large data populations need to be quickly compared to each other to find identical, similar or common data.
(e) Multi-variable (multi-dimensional) data mining such as weather analysis or stock price analysis needs to be done.
(f) Data needs to be searched realtime even when a large number of accesses are made on a large amount of data as in communication routers, social networks, Web searches, etc.

### (2) Queries Cannot be Determined

(a) Not knowing what to look for in the initial stage such as in data mining.
(b) Numerous options exist and optimal queries are unknown as in “go” or “shogi” games.
   (3) Preprocessing and/or Complex Processing Need to be Eliminated
(a) Substantial preprocessing is necessary in order to create indices.
(b) Exhaustive classification and/or clustering of AI techniques require preprocessing and/or learning.
(c) Complex software algorithms are difficult for non-experts and unusable for lay users.

As above, there are large potential needs expected for exhaustive and combinatorial comparison operations in various fields, and exhaustive and combinatorial comparison operations may be widely utilized not only in the IT industry, but also in every other sector including persona usage.

### DESCRIPTION OF THE REFERENCE NUMBERS

101 . . . data comparison operation processor
102 . . . data input
103 . . . row data input line
104 . . . row data
105 . . . row data address
106 . . . row data address buffer
107 . . . row data operation data line
108 . . . column data input line
109 . . . column data
112 . . . column data operation data line
113 . . . computing unit
114 . . . comparison computing unit
114 . . . K comparison computing unit
114 . . . comparison computing unit
116 . . . computing unit condition
119 . . . match address
120 . . . operation result output
121 . . . row-column match circuit
122 . . . computing unit
127 . . . temporary storage register
128 . . . number-of-matches counter
129 . . . priority determination circuit
130 . . . match address output
141 . . . address selection line
142 . . . bit line
145, 146 . . . switch
147 . . . memory cell address selection line
148 . . . memory cell data line
149 . . . memory cell
151 . . . entire exhaustive and combinatorial operation space
152 . . . 1-batch operation space
153 . . . data of 1-batch memory space

1. A data comparison operation processor, provided with 2 sets of memory groups consisting of 1 row and 1 column, each capable of storing n and m data items respectively, and n+m data items in total; and n×m computing units at cross points of data lines wired in net-like manner from the 2 sets of memory groups,
the data comparison operation processor, comprising means for sending in parallel the respective data items, consisting of n data items for 1 row and m data items for 1 column, to the data lines wired in net-like manner from the 2 sets of memories of 1 row and 1 column, and causing the n×m computing units to read the sent data items of the rows and columns exhaustively and combinatorially, to perform parallel comparison operations on the data items of the rows and columns exhaustively and combinatorially, and to output results of the comparison operations.

2. The data comparison operation processor of claim 1, wherein the data lines wired in net-like manner are multi-bit data lines, and the computing units are ALU (Arithmetic and Logic Unit) for executing matrix comparison operations in parallel.

3. The data comparison operation processor of claim 1, wherein the data lines wired in net-like manner are 1-bit data lines, and the computing units are 1-bit comparison computing units for executing matrix comparison operations in parallel.

4. (canceled)

5. The data comparison operation processor of claim 1, wherein the 2 sets of memory groups of 1 row and 1 column comprise a memory for storing exhaustive and combinatorial data in a matrix range, which is K times of data required for 1 batch of n×m exhaustive and combinatorial operations, wherein the n×m computing units comprise a function for continuously executing (K×n)×(K×m) exhaustive and combinatorial operations.

6. The data comparison operation processor of claim 1, wherein the data comparison operation processor performs matrix transformation on the data items and stores them in the 2 sets of memories of 1 row and 1 column when externally reading and storing the n and m data items.

7. The data comparison operation processor of claim 1, wherein the data comparison operation processor is implemented in a FPGA.

8. The data comparison operation processor of claim 1, provided with 3 sets of memory groups consisting of the 1 row, 1 column, and additional 1 page, each capable of storing n, m, o data items, and n+m+o data items in total; and n×m×o computing units at cross points of data lines wired in net-like manner from the 3 sets of memory groups.

9. A device, including the data comparison operation processor of claim 1.

10-12. (canceled)
